(19) United States
(12) Patent Application Publication
(10) Pub. No.: US 2005/0008829 A1
(43) Pub. Date: Jan. 13, 2005

(54) Systems and methods for creating and managing laboratory signage

(76) Inventor: Bevan D. Suits, Decatur, GA (US)

Correspondence Address: William R. Silverio;SUTHERLAND ASBILL & BRENNAN LLP, 999 Peachtree Street, NE, Atlanta, GA, 30309-3996, US

(21) Appl. No.: 10/658,444

(22) Filed: Sep. 8, 2003

Related U.S. Application Data
(60) Provisional application No. 60/408,731, filed on Sep. 6, 2002.

(51) Int. Cl. G06F 19/00; B32B 1/00

(52) U.S. Cl. 428/195.1; 428/187

(57) ABSTRACT

Systems and methods provide a network-accessible user interface that provides a user with tools for creating and managing laboratory signage. A user interacts with the interface in order to select pre-designed laboratory signage or to create custom laboratory signage. The user may select or create multiple laboratory signs, which may be associated with one or more laboratories or rooms. The user may subsequently retrieve one or more of the laboratory signs in order to print, electronically distribute, or edit, as desired. An interface permits the user to enter manually, import, select, calculate and/or create the desired text, graphics, and other information to be included on a laboratory sign and to select the desired layout for the sign from a menu of established templates.

### RELATED APPLICATION DATA

The present invention claims priority to U.S. Provisional Patent Application No. 60/408,731, filed on Sep. 6, 2002, titled “NETWORK-BASED SYSTEMS AND METHODS FOR CREATING AND MANAGING LABORATORY SIGNAGE AND RELATED DATA”, the entire contents of which are incorporated herein by reference as if set forth fully herein.

### FIELD OF THE INVENTION

The present invention relates generally to systems and methods for producing signage, and more specifically, to systems and methods for producing signage containing critical safety information.

### BACKGROUND OF THE INVENTION

Signage is used in hospitals, laboratories, industrial settings, and the like, to identify pertinent information such as health and safety information. For instance, in a laboratory setting, signage may indicate that materials within a room contain infectious or harmful materials thereby acting as a warning that the materials should be handled with care, or that persons entering the room should take caution (e.g., by dressing or handling themselves or materials appropriately).

Signage is particularly important in settings where conditions rapidly change. For instance, laboratory signage must be updated easily, quickly and efficiently due to rapid changes typical of a laboratory environment. Otherwise, harmful conditions and/or materials may not be adequately identified. In fact, any industrial facility with frequently changing conditions would benefit from the rapid identification of conditions via signage as a result of the reduction of injuries and damage to persons and goods when conditions are properly identified.

What is therefore needed is a system and method for enabling the rapid production and placement of signage to identify critical safety information in environments such as laboratories and industrial facilities.

### SUMMARY OF THE INVENTION

The present invention is directed to systems, methods and computer program products for producing signage containing critical, summarized safety information. Such signage may display any relevant text and pictogram images and can be used in laboratories, hospitals, industrial settings and the like.

More specifically, the present invention provides a network-accessible user interface, such as a website, that provides a user with tools for creating and managing laboratory signage. The term laboratory signage is used broadly herein and is intended to encompass any type of sign, display or label that is used to provide safety information, room identification and contact information in laboratory, hospital, pharmacy, industrial and other environments.

The user of the systems of the present invention may be a laboratory manager or another individual who is responsible for overseeing safety procedures. The user may interact with the interface in order to select pre-designed laboratory signage or to create custom laboratory signage. The user may select or create multiple laboratory signs, which may be associated with one or more laboratories or rooms. The user may subsequently retrieve one or more of the laboratory signs in order to print, electronically distribute, or edit, as desired.

The interface of the present invention may allow the user to enter manually, import, select, calculate and/or create the desired text, graphics, and other information to be included on a laboratory sign and to select the desired layout for the sign from a menu of established templates. Graphics can include universally understandable health and safety icons, such as those for radioactivity, fire, etc. The user-specified data (including graphics) needed to create the laboratory sign is stored in a database. The data in the database is then used to generate the laboratory sign. Laboratory signs may be generated as PDF files, or another common file format that captures the elements of a printed document as an electronic image that can be viewed, navigated, printed, etc. Laboratory signs can be created on demand from the database and downloaded to the user's computer desktop. Furthermore, laboratory signage can be created for printing and use on any surfaces such as, but not limited to, laboratory entrances, walls, equipment, chemical containers, gas cylinders, or hazardous waste containers. Displays can take the form of standard letter-sized paper.

According to one embodiment of the present invention, there is disclosed a signage producing system. The system includes at least one graphic selection interface, where the at least one graphic selection interface is operable to permit a user to identify at least one sign graphic, at least one database, where the at least one database is operable to store the at least one sign graphic and at least one sign template, and a signage application, where the signage application is operable to generate a sign by populating the at least one sign template with the at least one sign graphic.

According to one aspect of the invention, the at least one graphic selection interface is further operable to display multiple sign graphics. According to another aspect of the present invention, the at least one graphic selection interface is further operable to receive at least one sign graphic from the user. According to yet another aspect of the present invention, the system further includes at least one sign interface, wherein the sign interface is operable to display a plurality of signs generated by the user. The at least one sign interface may be operable to receive a selection from a user, the selection modifying the sign generated by the signage application. The at least one sign interface may also include at least one selection box, where the at least one selection box indicates whether the at least one sign graphic is included on the sign.

According to another aspect of the invention, the system can include a user, where the user is in communication with the at least one graphic selection interface via a network. The system can also include a sign preview interface, where the sign preview interface is operable to display the sign generated by the signage application. The system can further include a printer for printing the sign, and at least one personnel interface, wherein the personnel interface is operable to display personnel associated with the sign.

According to another embodiment of the present invention, there is disclosed a method for producing a sign. The method includes the steps of identifying at least one sign graphic, retrieving at least one sign template, where the at least one sign template determines the design of a sign, and generating a sign by populating the at least one sign template with the at least one graphic selection.

According to one aspect of the invention, the method may also include the step of associating at least one person with the sign, and/or the step of retrieving the at least one sign graphic from a database. According to another aspect of the invention, the step of identifying at least one sign graphic includes receiving the at least one sign graphic from a user. According to yet another aspect of the invention, the method further includes the step of altering the sign by altering the sign template. Additionally, multiple sign graphics may be displayed, and the generated sign may also be displayed and/or printed.

According to yet another embodiment of the present invention, there is disclosed a computer program product for producing a sign. The computer program product includes a computer usable medium having computer-readable code means embodied in the medium, the computer-readable code means including computer readable code means for identifying at least one sign graphic, retrieving at least one sign template, where the at least one sign template dictates the design of a sign, and generating a sign by populating the at least one sign template with the at least one graphic selection. The computer program product may also include computer readable code means for providing a user interface, the user interface permitting a user to identify the at least one sign graphic.

### BRIEF DESCRIPTION OF THE DRAWINGS

Having thus described the invention in general terms, reference will now be made to the accompanying drawings, which are not necessarily drawn to scale, and wherein:

FIG. 1 is a functional block diagram illustrating an exemplary embodiment of the present invention that is configured for creating customized facilities sign graphics.

FIG. 2 shows an exemplary pictogram selection interface screen that may be provided as a user interface in accordance with certain embodiments of the present invention.

FIG. 3 shows an exemplary sign database interface that may be provided as a user interface in accordance with one aspect of the present invention.

FIG. 4 shows an exemplary add lab interface that may be provided as a user interface in accordance with one aspect of the present invention.

FIG. 5 shows an exemplary sign preview interface that may be provided as a user interface in accordance with one aspect of the present invention.

FIG. 6 shows an exemplary search interface that may be provided as a user interface in accordance with one aspect of the present invention.

FIG. 7 shows an exemplary manage personnel interface that may be provided as a user interface in accordance with one aspect of the present invention.

FIG. 8 shows an exemplary manage facilities interface that may be provided as a user interface in accordance with one aspect of the present invention.

FIG. 9 shows an exemplary facilities reporting interface that may be provided as a user interface in accordance with one aspect of the present invention.

### DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

It will be appreciated that the methods of the present invention described herein with respect to the figures can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the flowchart block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the functions specified herein. Therefore, the methods described herein may be implemented by a modeling tool comprising a processor, operating system, memory, input/output interface, one or more databases and a bus.

Further, the methods described herein may be embodied as a data processing system or a computer program product on a computer-readable storage medium having computer-readable program code means embodied in the storage medium. Any suitable computer-readable storage medium may be utilized including hard disks, CD-ROMs, DVDs, optical storage devices, or magnetic storage devices. Accordingly, the present invention may take the form of an entirely hardware embodiment, an entirely software embodiment or an embodiment combining software and hardware aspects, such as firmware. According to a preferred embodiment, the methods described herein are implemented by a stand-alone software application operating on a Windows® operating system. However, the methods may be implemented using alternative operating systems and databases as are known to those of skill in the art.

The present invention provides network-based systems and methods for creating and managing laboratory signage, where laboratory signage refers to any signage that displays relevant information, such as hazard warnings, room identification, contact personnel etc. Safety information typically displayed on laboratory signage is often referred to as material safety data. However, the present invention contemplates that other safety information may be displayed on laboratory signage as well as material safety data.

According to one embodiment, the present invention provides a network-accessible user interface, such as a website, that provides a user with tools for creating and managing laboratory signage. Although the present invention is described with respect to a network embodiment, in which a user accesses tools for creating and managing laboratory signage via a network connection (e.g., a Local Area Network or a Wide Area Network), it will be appreciated that the tools of the present invention may be embodied in software located on a stand-alone computer. Using the present invention, a user may interact with the user interface to select pre-designed laboratory signage or to create custom laboratory signage. As noted above, the user may select or create multiple laboratory signs, which may be associated with one or more laboratory or room, and the user may subsequently retrieve one or more of the laboratory signs in order to print, electronically distribute, or edit, as desired.

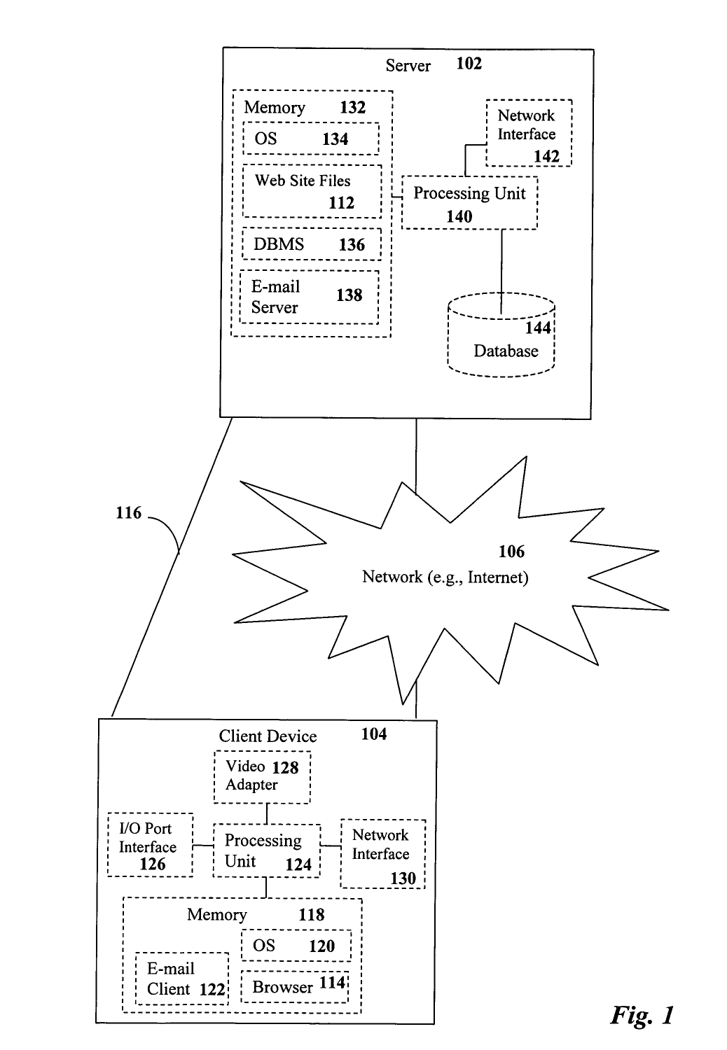

The user interface allows the user to enter manually, import, select, calculate and/or create the desired text, graphics, and other information to be included on a laboratory sign and to select the desired layout for the sign from a menu of established templates. Exemplary embodiments of the present invention will now be described with reference to the figures, in which like numerals are used to indicate like elements. An exemplary operating environment for implementation of the present invention is shown in block diagram form in FIG. 1.

As shown in FIG. 1, the exemplary operating environment may include a traditional client-server configuration, whereby a server 102 is accessible by a client device 104 via a network 106, such as via a Wide Area Network (WAN) such as the Internet. Accordingly, the server 102 may host a website including various website files 112, such as HTML files, XML files, JAVA files, and the like. Additionally, a client device 104 may be configured for execution of a browser 114 in order to interact with the website files 112 hosted by the server 102. As shown, a client device 104 may also communicate with the server 102 via a dedicated communications link 116 (or multiple dedicated communications links).

The client device 104 may be any Internet-enabled device, such as a desktop computer, a palmtop or laptop computer, a personal digital assistant, a mobile telephone, or any other processor driven device that is able to communicate with the resources of the network 106. While exemplary embodiments may be described herein with reference to the Internet or World-Wide-Web, it should be understood that any type of communications link may be substituted therefore. For instance, the client device 104 may communicate with the network 106 via a mobile connection using well-known communication protocols. Therefore, the present invention contemplates that a client device 104 may communicate with the server 102 by way of any known, emerging, or later developed communications protocol.

In general, a client device 104 may include a memory 118 for storing such things as an operating system 120, a browser 114, an e-mail client 122 and other program modules or data files. The client device 104 may also include a processing unit 124 for executing application programs stored within the memory 118, such as the browser 114 and the e-mail client 122. The client device 104 may further include one or more input/output (I/O) ports 126 for communicating with input and output devices such as a keyboard, mouse, microphone, speaker, printer, cradle, etc. As shown in FIG. 1, the client device 104 may also include a video adapter 128 for communication with a display device, and a network interface 130 for communication with the network 110 or dedicated communications link 116. As will be apparent to those of skill in the art, a client device 104 may include additional features and components that are not shown in FIG. 1.

Referring once again to the server 102, the server 102 may include a conventional computer system configured to function as a network server. For example, the server 102 may include a memory 132 for storing a server operating system 134, a database management system (DBMS) 136, web-site files 112, an e-mail server 138, as well as other program modules and data files. The server 102 may further include a processing unit 140 and a network interface 142, where the processing unit effects the functions of the server 102 in conjunction with the operating system 134 and systems and/or data residing in memory 132. The server 102 may also include or be in communication with one or more databases 144 that store sign templates and other data used in creating laboratory signage.

According to one aspect of the present invention, the one or more databases 144 for storing sign templates and other data for use in creating laboratory signage are local to the server 102. However, it will also be appreciated by those of skill in the art that the one or more databases 144 may also be geographically remote from the processing unit 140 and/or server 102. For instance, the database 144 may be in communication with the server 102 via the network 106 or one or more dedicated communication lines. Moreover, one or more of the applications, systems, files or data within the server 102 and/or client device memory 118 may also be located geographically remote from the server 104 and/or client device 104 where those are in communication with the server 102 and/or client device 104.

Sign templates stored in the database 144 may be pre-configured. Templates for laboratory signage may include arrangements of data fields and image fields such that the location of signage data and images are automatically provided for once a template is selected. According to one aspect of the present invention, at least one template is a default template when the user fails to select a template. Additionally, a front template may be designed for the front of a laboratory sign and a back template may be designed for the back of a laboratory sign. These templates may be associated with each other such that a user need not separately identify corresponding front and back templates. For instance, a user may be provided with the option to select and/or create a front template and a back template. Alternatively, the selection of a front template may be dictate the back template to be used with the sign and vice-a-versa.

Using the interface of the present invention, a laboratory sign may be created by importing the data into the data fields of the template and by importing images into the image fields of the template from a library of pictograms. Data, such as room identification, emergency contact information, laboratory location information, etc., may be pre-populated in the database 144 or may be input by the user. The creation of templates, and the graphical user interfaces described below, may be executed by the processing unit 140 operating in conjunction with the web site files. According to one aspect of the present invention, the web site files 112, servers 138, DBMS 136, OS 134 within the memory 132, and the processing unit 140 include a signage application.

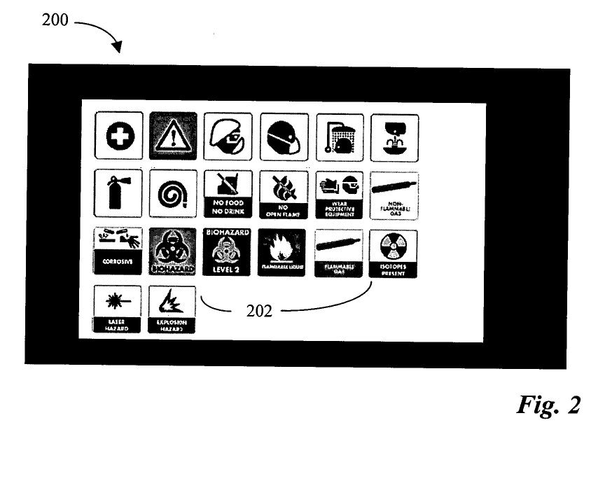

FIG. 2 shows an exemplary pictogram selection interface screen that may be provided as a user interface in accordance with certain embodiments of the present invention. According to one aspect of the present invention, the pictogram selection interface is a graphical user interface generated by the processing unit 140 of the server 102 operating in conjunction with the OS 134 and one or more web site files 112 and/or data files from the database 144.

The pictogram selection interface 200 allows a user to select graphic images to be included on a laboratory sign from a virtual library of pre-designed pictograms 202. According to one aspect of the invention, the pictograms are small graphics files presented in thumbnail or filmstrip view, as is known to those of skill in the art. Furthermore, although not illustrated, users may specify their own pictograms and template if existing pictograms and templates are not satisfactory. Therefore, the interface 200 may also include an upload or browse button to enable a user to identify a particular pictogram, such as one stored locally on the user's computer or on the server.

As shown in FIG. 2, the pictograms 202 typically included on a laboratory sign relate to hazards and precautions. Hazards and precaution pictograms in the application preferably reflect what is commonly used in the Health and Safety field and are based on ANSI (American National Standards Institute) standards for color and design. However, one or more customized pictograms may also be uploaded for selection via the interface 200. Additionally, the interface 200 may also include multiple folders or pull down menus to permit pictograms to be grouped logically. The original grouping may be effected by a system administrator and the user may be able to add or delete pictograms from the interface 200 using add and/or delete commands.

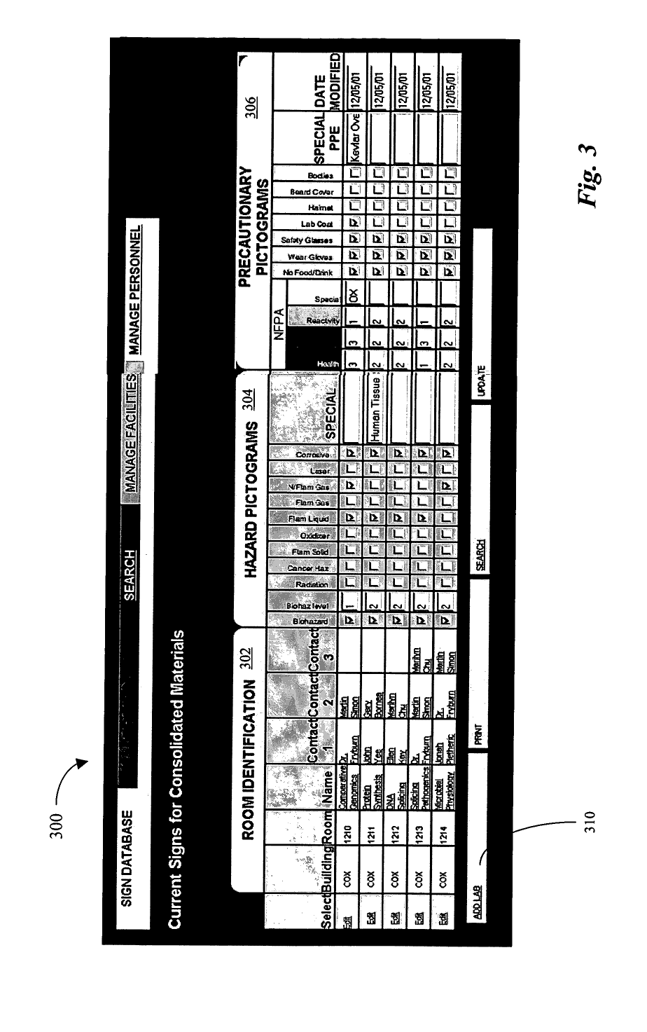

FIG. 3 shows an exemplary sign database interface 300, according to one aspect of the present invention. The sign database interface 300 may be used to present the user with a concise summary of all laboratory signage that the user has created. The user may use the sign database interface 300 to manage laboratory signage for multiple campuses, buildings and/or rooms. In the illustrative embodiment shown in FIG. 3, the sign database interface 300 is arranged as a gird with each row representing a different laboratory sign. The grid generally includes room identification 302, hazard pictograms 304, and precautionary pictograms 306 sections.

The room identification section 302 of the grid may identify the building, room, room name and contact information for each laboratory sign. According to one aspect of the invention, one or more of those fields are populated with links. For instance, where room name or contact information is provided, each may be a clickable link, such that additional information may pop-up when the link is selected. According to one aspect of the present invention, the links may include links to an email program that automatically populates the ‘To:’ email field such that an email to a person or company may be composed and transmitted.

Next, the hazard pictograms section 304 may identify the pictograms and other hazard information that are currently chosen for display on each laboratory sign. According to one aspect of the invention, checked boxes are located under fields including: biohazard, radiation, cancer hazard, flam solid (i.e., flammable solid), oxidizer, flam liquid, flam gas, n/flam gas, laser, and corrosive. Checked boxes there under indicate that a hazard pictogram is included on a sign, while unchecked boxes indicate that the hazard pictogram is not included. The user may change the selection of hazard pictograms by checking and/or un-checking the appropriate check boxes. Special hazard information may also be entered into text fields for display on a laboratory sign as text or as a custom pictogram, as illustrated in the illustrative example of FIG. 3 as the ‘Special’ field.

The precautionary pictograms section 306 may be used to display the precautionary pictograms, National Fire Protection Agency (NFPA) information, and special precautionary measures that are currently selected for display on a laboratory sign. The precautionary pictograms section 306 may also include other information, such as the date on which the sign content was last modified and special precautionary pictogram information. Checked boxes indicate that a precautionary pictogram is included on a sign, while unchecked boxes indicate that the precautionary pictogram is not included. The user may change the selection of precautionary pictograms by checking and/or un-checking the appropriate check boxes. Special precautionary information and NFPA information may also be entered into text fields for display on a laboratory sign as text or as custom pictograms.

Those skilled in the art will appreciate that NFPA codes are defined by a rigorous classification system developed by the NFPA. NFPA codes are typically displayed in a “NFPA diamond” graphic and communicate the relevant hazards, proper protective equipment and extinguishing media necessary to properly handle and safely respond to a chemical spill, fire or explosion. The database 144 allows the user to choose the maximum NFPA code for that sign from a dropdown menu.

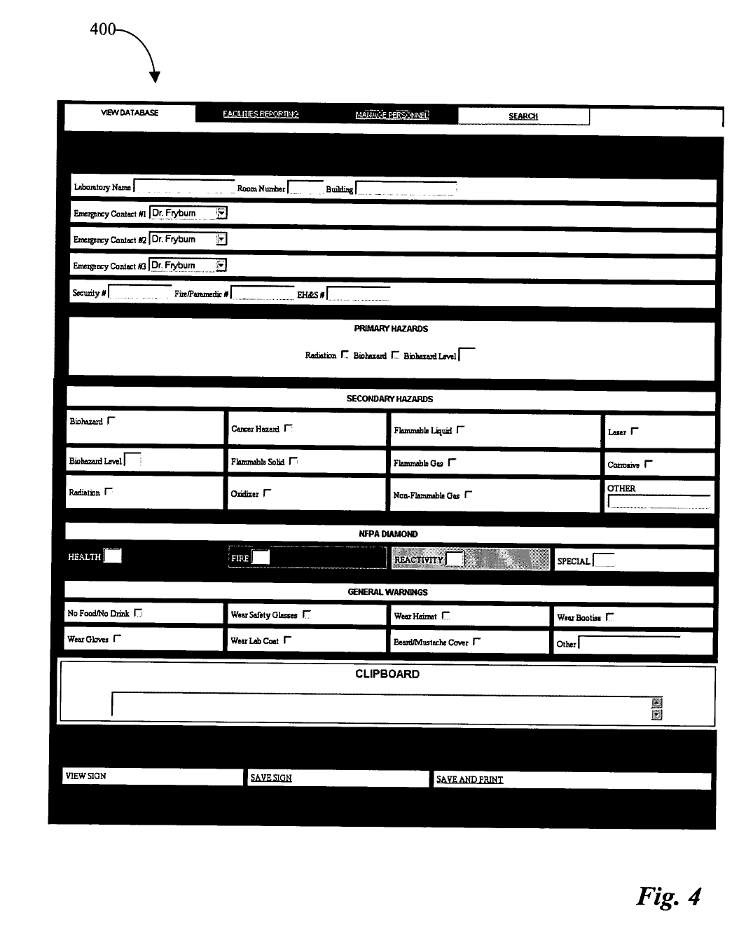

The exemplary sign database interface 300 also includes multiple links to allow a user to access additional features. For instance, the user may select an add lab link 310, which will present the user with an add lab interface 400, an illustrative example of which is shown in FIG. 4. The sign database interface 300 further includes five links along the top of the graphical interface, including links to a facilities report, search, manage facilities, and manage personnel. Numerous interfaces described below contain these links, and a link back to the sign database interface 300, such that any of the interfaces described herein may be accessed by the user by selecting one of these links from each of the interfaces.

Referring now to FIG. 4, the add lab interface 400 may be provided in order to specify new lab and laboratory signage. The add lab interface 400 may be displayed in response to user activation of an add lab link 310 or other control provided on the sign database interface 300. As illustrated in FIG. 4, the interface 400 permits a user to input the building, room, room name and contact information for each laboratory sign, along with primary and secondary hazard information. As with the prior interfaces described above with reference to FIGS. 2 and 3, information may be entered by a user via typing or by clicking on one or more boxes. The interface 400 also allows a user to identify the NFPA diamond that will be used, and general warnings that will be included on the signage. Thereafter, one or more links permit the user to view the sign, save the sign, and/or print the sign.

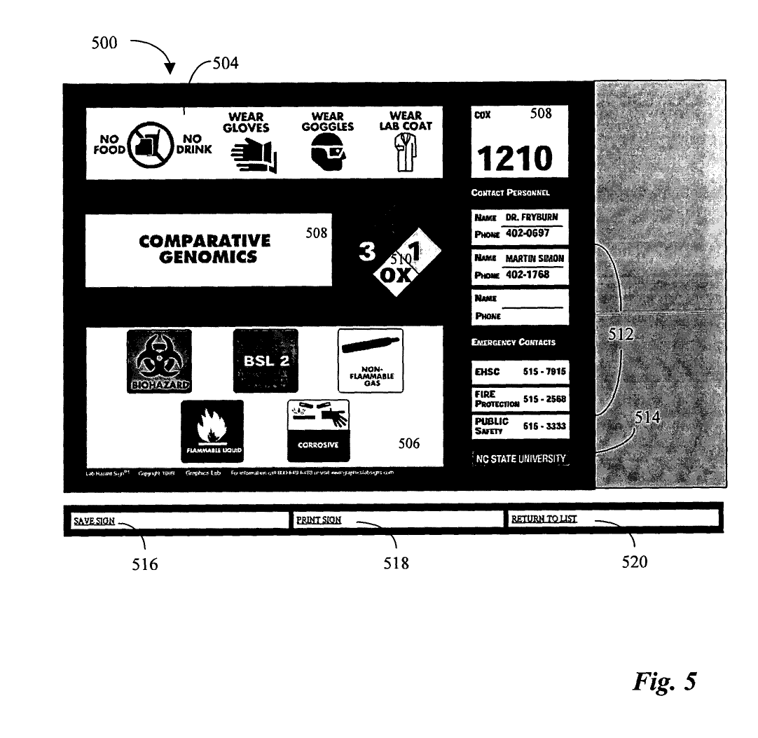

FIG. 5 shows an exemplary sign preview interface 500. The preview interface 500 is provided to the user once the user selects the view link on the add lab interface 400 of FIG. 4 and provides for the previewing of laboratory signage. The view sign interface 500 may be presented in response to user activation of a sign preview button. As mentioned previously, a laboratory sign may be created by the processing unit 140 by populating a template with the appropriate graphical and textual information. The selected template may include designated fields for importing pictograms and text from the database 144. By way of illustration, the template shown in FIG. 5 may include a precautionary pictogram field 504 for importing selected precautionary pictograms and a hazard pictogram field 506 for importing selected hazard pictograms.

Lab identification fields 508 and contact fields 512 may be provided on the template for importing text representing the specified lab name, contact personnel and emergency contact information. A NFPA diamond 510 may also be displayed for importing specified NFPA codes. Because templates are used to determine the position of text and graphics, including pictograms, alternative templates may be selected to vary the format of the signage. Furthermore, templates can be designed to include any other fields that may be desired by the user. In one example, the template may provide a logo field 514 for importing a company logo. The template may also be configured such that imported pictograms or text are automatically sized, positioned and formatted to fit within a given field of the template. Moreover, the view sign interface 500 may be displayed in full color, so as to accurately represent the laboratory sign that could be printed.

As shown in FIG. 5, the view sign interface 500 (or sign preview interface) may also provide the user with several command options, such as a “save sign” link 516, a print/preview sign link 518 and a return to list link 520. Activation of the save sign link 516 will cause the database 144 to be updated, if necessary, to store the displayed version of the laboratory sign. Activation of the print sign link 518 may cause the sign to be generated in a standard document format, such as PDF. The standard document format may then be sent to a local or network printer or may be electronically shared with other users via the network 106.

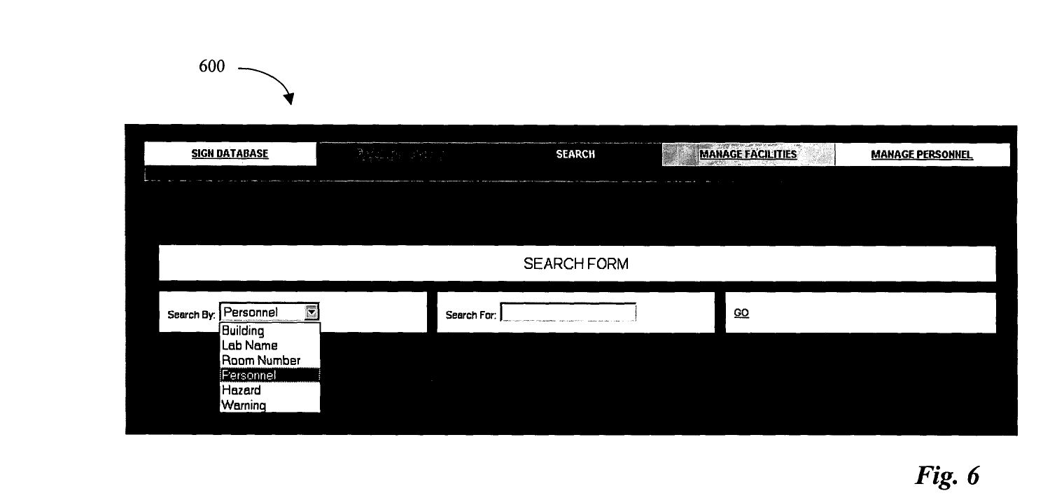

The database 144 for storing laboratory signage data may be a full-function database, meaning that it may be used to sort, search and compile data into reports either on demand or automatically. For example, a search interface 600, as shown in FIG. 6, may be provided for searching the database 144 based on user-selectable search criteria. As shown in FIG. 6, the search may be limited to a building, lab name, room number, personnel name, hazard, warning, like fields, or all of the above. The search engine will then search those selected fields for the query entered by the user in a search box, and all signs meeting that criteria will be identified. The search engine is operable to search for the user input terms in the database 144, DBMS 136, web site files 112, or any other database used to store signs, pictograms and text.

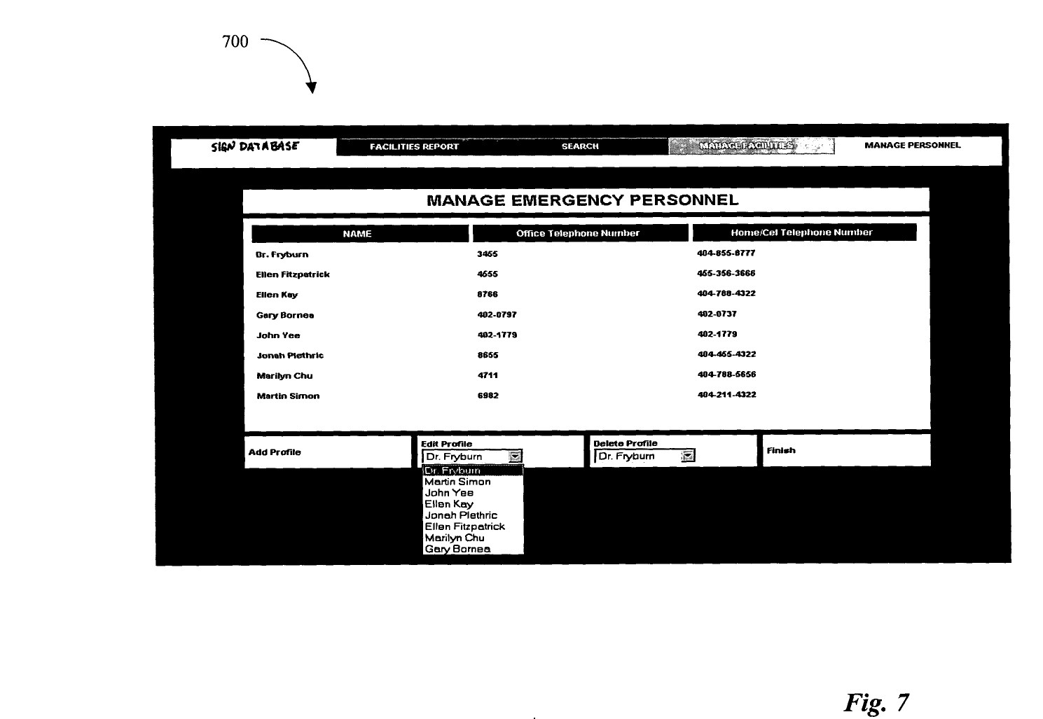

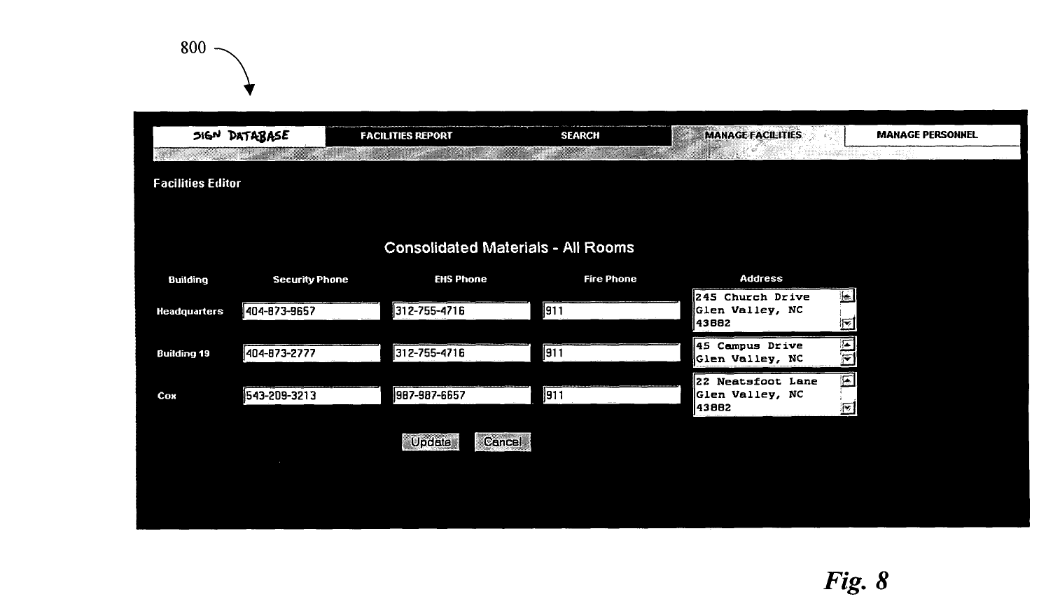

In addition, a manage personnel interface 700, as shown in FIG. 7, may be selected from links on the other interfaces described herein and illustrated in the figures. The manage personnel interface 700 is used to display the names and contact information for all personnel associated with the laboratory signs that are managed by a particular user. The manage personnel interface 700 may provide controls for adding, deleting and editing personnel profiles. A manage facilities interface 800, as shown in FIG. 8, may also be provided for displaying the names, locations and emergency contact information for all buildings that are managed by a particular user.

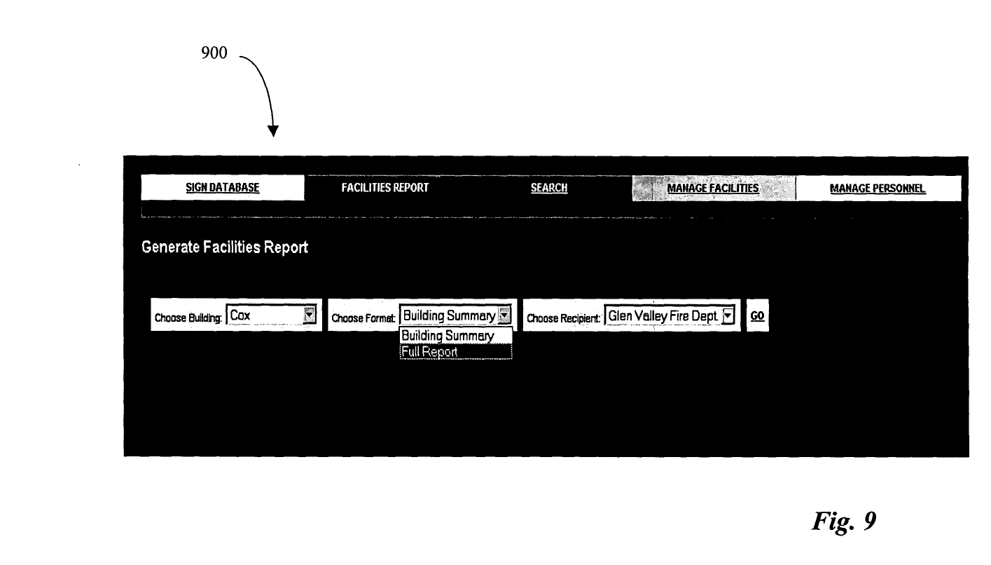

A facilities reporting interface 900, as shown in FIG. 9, may also be provided for generating reports for each facility that is managed by a particular user. When the user specifies the type of report desired, a reporting application is operable to generate the report and displays it on the screen. The reports may be generated in pre-defined formats and may be individually customized by the user. Reports may be sent electronically or in hard copy to certain designated third-parties, such as emergency response personnel. Reports may also be generated automatically. Reports may be useful to insurance companies that look for spikes of risk on behalf of a company and can help reduce risk by designing messages that communicate better.

Those skilled in the art will appreciate that other and/or additional interfaces may be provided without departing from the spirit and scope of the present invention. In addition, other functionality may be provided in order to provide a more robust system for creating and managing laboratory signage. For example, in certain embodiments functionality may be provided for importing databases of chemical inventory for inclusion on a laboratory sign. In addition, the interfaces of the present invention may be configured with wizard-type functionality for guiding the user through the variety of options for selecting desired data and graphics for display.

In certain other embodiments, the server 102 may be in communication with a third-party printing service, so that the user can electronically request professionally printed laboratory signs on a particular substrate, such as a laminated page or an adhesive film. The server 102 may manage transactions between the user and the third-party printing service, if desired. If appropriate, the sever 102 and/or the third-party printing service may perform transaction settlement by way of electronic finds transfer.

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the present invention may be embodied in many forms and should not be limited to the embodiments described above. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A signage producing system, comprising:
at least one graphic selection interface, wherein said at least one graphic selection interface is operable to permit a user to identify at least one sign graphic;
at least one database, wherein the at least one database is operable to store the at least one sign graphic and at least one sign template; and
a signage application, wherein the signage application is operable to generate a sign by populating the at least one sign template with the at least one sign graphic.

2. The system of claim 1, wherein the at least one graphic selection interface is further operable to display multiple sign graphics.

3. The system of claim 2, wherein the at least one graphic selection interface is further operable to receive at least one sign graphic from the user.

4. The system of claim 1, further comprising at least one sign interface, wherein said sign interface is operable to display a plurality of signs generated by the user.

5. The system of claim 4, wherein the at least one sign interface is operable to receive a selection from a user, said selection modifying the sign generated by the signage application.

6. The system of claim 4, wherein the at least one sign interface comprises at least one selection box, wherein said at least one selection box indicates whether the at least one sign graphic is included on the sign.

7. The system of claim 1, further comprising a user, wherein the user is in communication with the at least one graphic selection interface via a network.

8. The system of claim 1, further comprising a sign preview interface, wherein said sign preview interface is operable to display said sign generated by said signage application.

9. The system of claim 1, further comprising a printer for printing said sign.

10. The system of claim 1, further comprising at least one personnel interface, wherein said personnel interface is operable to display personnel associated with the sign.

11. A method for producing a sign, comprising:
identifying at least one sign graphic;
retrieving at least one sign template, wherein the at least one sign template determines the design of a sign; and
generating a sign by populating the at least one sign template with the at least one graphic selection.

12. The method of claim 11, further comprising the step of associating at least one person with the sign.

13. The method of claim 11, further comprising the step of retrieving the at least one sign graphic from a database.

14. The method of claim 11, wherein the step of identifying at least one sign graphic comprises receiving said at least one sign graphic from a user.

15. The method of claim 11, further comprising the step of altering said sign by altering said sign template.

16. The method of claim 11, further comprising the step of displaying multiple sign graphics.

17. The method of claim 11, further comprising the step of displaying the generated sign.

18. The method of claim 17, further comprising the step of printing the generated sign.

19. A computer program product for producing a sign, said computer program product comprising:
a computer usable medium having computer-readable code means embodied in said medium, said computer-readable code means comprising computer readable code means for:
identifying at least one sign graphic;
retrieving at least one sign template, wherein the at least one sign template dictates the design of a sign; and
generating a sign by populating the at least one sign template with the at least one graphic selection.

20. The computer program product of claim 18, further comprising computer readable code means for providing a user interface, said user interface permitting a user to identify the at least one sign graphic.
